(19) United States
(12) Patent Application Publication
(10) Pub. No.: US 2017/0291498 A1
(43) Pub. Date: Oct. 12, 2017

(54) Electric vehicle charger connections made by vehicle motion only

(71) Applicants: Sten R. Gerfast, Mendota Heights, MN (US); Aric Rasmussen, Spring Valley, WI (US)

(72) Inventors: Sten R. Gerfast, Mendota Heights, MN (US); Aric Rasmussen, Spring Valley, WI (US)

(21) Appl. No.: 14/999,184

(22) Filed: Apr. 9, 2016

(51) Int. Cl. B60L 11/18; H02J 7/02; H02J 7/00

(52) U.S. Cl. CPC B60L 11/1833; B60L 11/1818; B60L 11/182; B60L 11/1829; B60L 11/1825; H02J 7/0027; H02J 7/025; B60L 2230/12; B60L 2230/14

(57) ABSTRACT

Automatic, dual power, inductive and electrical, vehicle charge station.

This invention is a convenient, automatic, electric vehicle charge station, where the driver does nothing except driving in. It can have two charge methods:

A. Electrical conductive power with efficient dual contact transfer of either AC or DC to a vehicle. It can have the dual contact closure actuated by magnetic attractive force.
B. Inductive power transfer with mating primary and secondary inductors that inductively transfers power to a vehicle by a transportable charge station.

For safety, the charge station has unique E-type laminations located front-to front, unique self releasing electrical contacts, and unique, self closing, safety sleeves.

The self releasing contacts prevents damage to the vehicle, or to the charger in case of angry driver drive-off.

Many other different systems are also described for touch protection of contacts and guidance and of the vehicle into the charge station.

This application claims the benefit of U.S. Provisional Application No. 62/283,312. filed on Aug. 27, 2015, with the same inventors.

### BRIEF SUMMARY OF THE INVENTION

This invention is for a convenient, automatic, electric vehicle charge station. Described in details is the necessary sequences to do this,

using solely vehicle motion for the charging,

The charger is having AC or DC powered electrical connectors automatically being coupled with receiving type electrical connector in a vehicle. This is using solely the vehicles motion, moving towards the charger, to achieve this coupling. It is thereby transferring electric conductive power to the vehicle automatically. The user of this charge station is provided with maximum convenience, without having to attach or manipulate anything in the vehicle's charger, or charger in the station. Additionally, an alternate induction charge method is also shown. Instead of mechanically and electrically coupling, the charge is by mating primary and secondary inductors. They do inductively transfer AC power from a transportable primary charger to a secondary inductor in a vehicle. Again, the user of this charge station is provided with maximum convenience. This is without having to attach or manipulate anything in the vehicle, or in the charge station,

### BACKGROUND OF THE INVENTION AND DESCRIPTION OF THE INVENTION

Convenience is requested by many customers in the market place today.

Persons that own electric vehicles today, would also like to have a convenient way of charging their battery in their vehicle. With the fast pace of the modern life today, it is also natural for them to combine a battery charge with a stop, while they are having breakfast, lunch or dinner, either in a curb service or sit down arrangement.

Or combining their entertainment or a service appointment with a fill up of their battery. With more and more electric vehicles on the road this invention responds to both the above mentioned needs. Plus all the other needs in the future where this charge station is perfect for Automatic charging of cars, trucks, motor cycles, golf carts, all terrain vehicles and garden and farm tractors.

The driver only needs to drive in to the charge station, and might recognize the license plate, and perhaps even have the owners credit card on file, to automatically get a charge.

This is without the driver having to attach or manipulate anything in the vehicle or manipulate cables in the station.

The primary charger is pivoted, and can be folded down in case of an emergency, or angry driver drive off, without doing any damage to the vehicle or the station. Of course, the folding of the primary can also be used in a drive-in-drive-out type, rather then a drive-in back-out.

The vehicles “secondary” can be mounted around the standard license plate, which is commonly mounted centered on vehicles in North America, Europe and Asia. This type of license plate is also having common dimensional standard in most countries.

When the vehicle is approaching the primary inductor

Prior art vehicles normally have heavy plug-in cables which are hand-inserted into an opening for the heavy cable, normally considered to be a nuisance.

This invention eliminates this annoyance and provides for an automatic convenient method of charging all vehicles.

Some of the above described features in this invention are unique. A person skilled in the art, might modify some of these features, but he or she would also find many of the described features in this invention to be unique.

### BRIEF DESCRIPTION OF THE DRAWINGS

FIG. 1 is a electric car charge facility showing a vehicle approaching a foldable charger mounted on the ground.

FIG. 2 is a closer view of the same foldable charger.

FIG. 3 is showing a detail of the contacts on the top of the foldable charger.

FIG. 4 is a second type of charger with 2 co-acting inductors, showing a vehicle which is having a secondary inductor mounted in a vehicle, and a primary inductor, immediately below, mounted on the ground.

FIG. 5. is a detailed view of the components in FIG. 4.

FIG. 6. is a third type of charger with electrical conducting contacts on the side of a vehicle approaching a stand with primary electrical contacts, mounted on the ground.

FIG. 7 is a detail of the stands components.

FIG. 8 is showing components attached to the vehicle

### DETAILED DESCRIPTION OF THE DRAWINGS

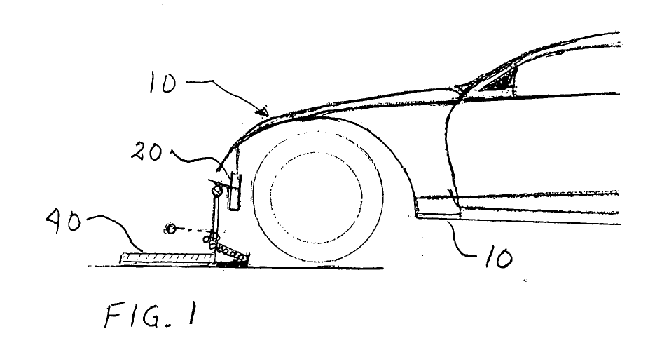

FIG. 1 is showing an electric vehicle 10 having a front mounted charge module 20, mounted at 30 in the front of the vehicle 10, ready to get charged from a foldable charger 40 mounted on the ground.

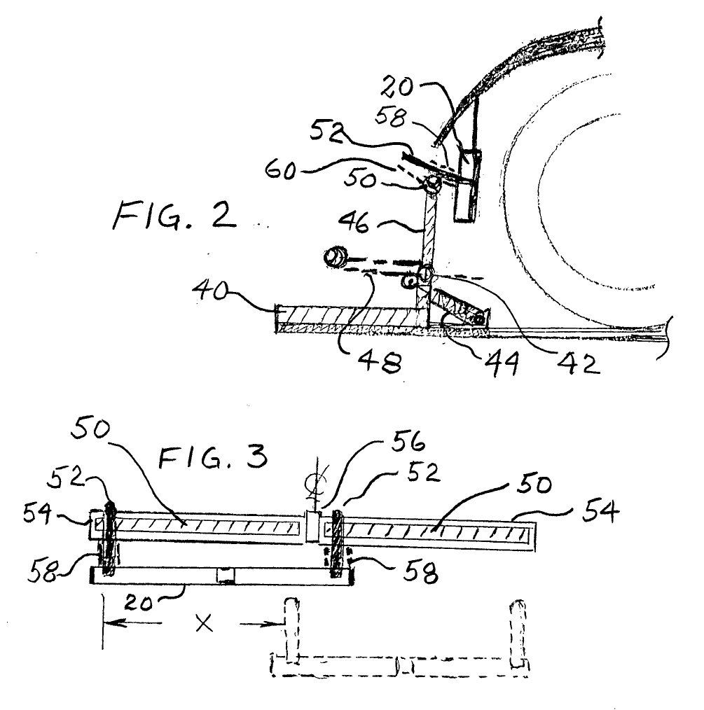

FIG. 2 is a closer view of the same foldable charger 40 mounted on the ground.

The foldable charger 40 is shown with a hinge 42 making it foldable and to make it to be able to pass under the vehicle 10. A spring 44 makes the top L-shape 46 spring-loaded, to be able to move forward and back, and to also accommodate a vehicle 10 different height positions. Dashed lines 48 shows L-shape 46 in a position after folding. Top mounted contacts 50 on the top of L-shape 46. Contact 50 are normally touch protected by a insulating membrane 60 pushed away by contacts 52 on the module.

During charging, contacts 50 are transmitting electric current to contacts 52 on the module 20. Because of the angled position of the contacts 52 and the spring-load 44 a secure electrical connection is made.

FIG. 3 is showing a detail of the contacts on the top of the foldable charger.

Top mounted 2 contacts 50 are shown in a top view with each contact 50 spaced equally from the center on the L-shape. The contacts 52 on the module 20 is shown contacting contacts 50. Both contacts 50 have insulation 54 and also a center insulator 56. They are also touch protected by a retractable sleeve insulator 58.

The contacts 52 on the module 20 are spaced to allow the greatest leeway (X position [stated in the claims]) for the vehicles left and right position in front of the chargers top mounted contacts 50. Normally the contacts are centered, but in FIG. 3 is indicated, first, a far left position, and secondly, (in dashed lines) showing the far right position. Also indicated is the large leeway X for the vehicle to be charged even though it is not centered.

As mentioned before, because of the angled position of the contacts 52 and the spring-load 44, a secure electrical connection is made between contacts 50 and 52 . . . .

FIG. 4 is a second type of charger with 2 co-acting inductors, showing a vehicle 10 which is having a secondary inductor 60 mounted in the vehicle 10, and a primary inductor 62, immediately below, mounted on the ground. It is showing how both 60 and 62 are in close contact. They are also protected from the environment with covering, and a waterproof bellows 66.

to assure god environmental protection.

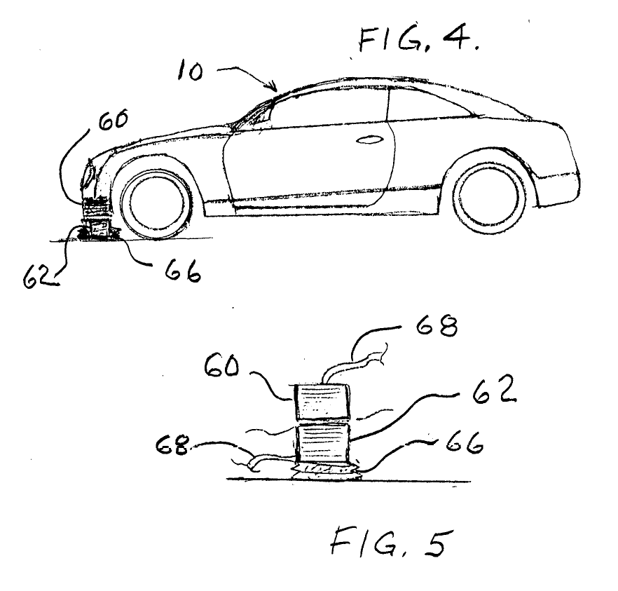

FIG. 5. is a detailed view of the components in FIG. 4. It is showing the vehicle 10 having an attached primary inductor 60 contacting the primary inductor 62.

Both the primary inductor 62 and secondary inductor have at that contact point a very thin non-magnetic stainless steel cover for good magnetic performance. Heavy duty cables 68 to allow for high current is attached to both inductor 60 and 62. It is also showing a waterproof bellows 66. The bellows allows movement and physical contact between primary 62 and secondary 62 and to achieve good magnetic coupling between the two.

This movement can be with magnetic attraction or motorized motion.

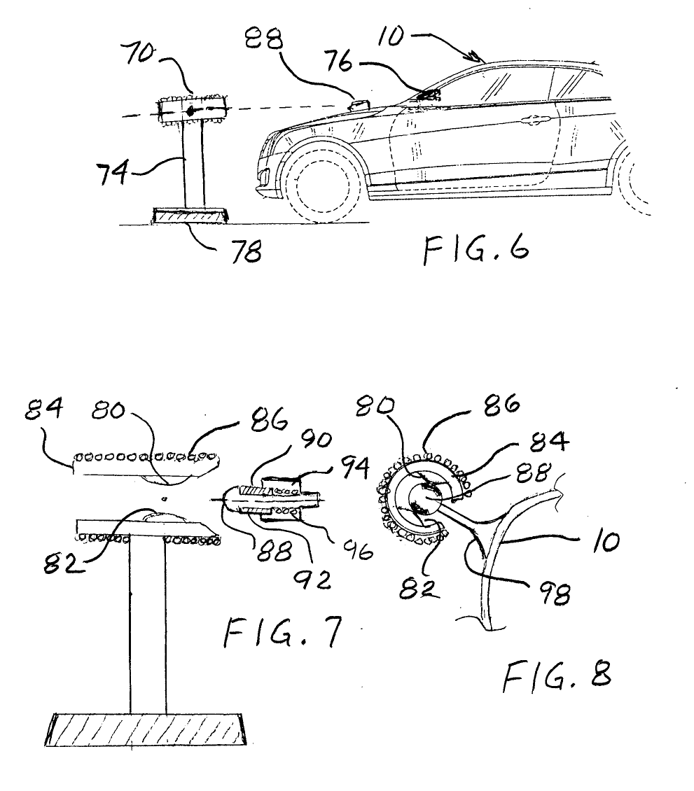

FIG. 6. is a third type of electrical conduction charger 70 with electrical conducting contacts inside a stand 74 mounted on the ground. and located by the side of a vehicle 10.

The stand 74 is low enough to pass under the vehicles 10 rear view mirror 76 and is far enough sidewise from the vehicle to prevent scraping. The stand 74 has a platform 78 secured to the ground.

FIG. 7. is a closer view of the same charger.

with primary electrical contacts 80 and 82 inside a tubular part 84, which can be pivoted for alignment, with an outside cloth covering 86 to prevent scratching of the vehicle's finish. A bullet-nose connector 88 (also shown in FIG. 6 on the vehicle) is having two connectors 90 and 92 for contacting contacts 80 and 82. A touch protecting sliding sleeve 94 is having a return spring 96.

FIG. 8 is a side view of the tubular part 84 with cloth covering 86 and two contacts 80 and 82. In the central section of the tubular part 84 is the bullet-nose part 88 shown with attachment 98 to the vehicle 10

The description above is not necessarily all the details of this invention. There are modifications that can be made within the scope of the invention That are obvious to a person skilled in the art.

### SUMMARY OF THE UNIQUE FEATURES OF THIS INVENTION

* Driver only drives up . . . charging is done automatically.
* Automatic charge, no cables to attach.
* Protection from “angry driver drive-away”, without damage.
* Charger folds down . . . allowing “Drive-thru”
* Lights indicates electrical connection and charge finish . . . .
* Simple construction, Less expensive then present “charger cables.”
* Or in short: Automatic, dual power, inductive and conductive vehicle charge station.

1. An electric vehicle charger's connections actuated by vehicle motion only, comprising:
an electric vehicle charger's connections actuated by vehicle motion only,
the charger having powered primary contacts, touch-protected by a movable shield,
a vehicle having secondary contacts also touch-protected by a movable shield, wherein, when the vehicle moving towards the charger and touching it, it is thereby displacing the first and second shields exposing both primary and secondary contacts, wherein when the vehicle continues to move forwards it is thereby establishing electric connection between primary contacts onto secondary contacts.

2. An electric vehicle charger's connections actuated by vehicle motion only comprising:
an electric vehicle charger's connections actuated by vehicle motion only,
the charger having powered primary left and right contacts,
protected from touching by a movable first shield above the primary contacts,
with the spacing between the left and right contacts being substantial,
allowing a vehicle to do a centered, left approach or right approach onto establishing connections with the charger,
a vehicle having secondary left and right contacts
protected from touching by a movable second shield above the secondary contacts, when the vehicle is moving towards the charger and touching it, it is thereby displacing the first shield and second shield exposing both the primary and secondary contacts, wherein when the vehicle continues to move forwards it is thereby establishing electrical connection between primary contacts onto secondary contacts.

3. A dual transformer charging system comprising:
an electric vehicle charger having a primary transformer placed on the ground wherein the transformer can be movable up-wards and down-wards and is covered by a waterproof container,
a vehicle having a similar secondary transformer
also covered by a waterproof container
wherein, when the vehicle is driven to be above the primary transformer
and is moved up-wards to be in close contact with the secondary vehicle transformer, energizing of the primary transfers magnetic energy
to the secondary vehicle transformer.

4. An electric vehicle charger having left and right contacts, according to claim 2 an electric vehicle charger having left and right contacts, both with an x length closely spaced from a center point, a vehicle having left and right front contacts substantially spaced with an x length distance, wherein, when a driver aims the vehicle forwards, the driver has a left to right allowance of substantially an x length distance, and still make the chargers and the vehicle's contacts meet.

5. An electric charger connectable to an electric vehicle according to claim 2 wherein the vehicles forwards motion provides solely for the connections, without any other manipulation, and a further vehicle forward motion will allow the vehicle to proceed forwards and disconnect the electrical contacts.

6. An electric charger connectable to an electric vehicle according to claim 1 wherein the chargers contact envelope is swivel-mounted in the tower to allow the envelope to move left and right, as well as up and down.

7. An electric charger connectable to an electric vehicle according to claim 1 wherein the chargers envelope is mounted on a hinge.

8. An electric charger connectable to an electric vehicle according to claim 1 wherein the chargers contact envelope is mounted on a hinge connected to the tower, allowing the envelope forward and back motion from its normal centered position, and a spring to assure its return to normal.

9. A charger and a vehicle contacts meting according to claim 1
with both the charger and a vehicle contacts touch-protected by a movable shield, wherein, when a driver aims the vehicle forwards, the vehicle is displacing both shields exposing both charger and vehicle contacts.

10. Automatic, dual power, inductive and conductive charge station according to claim 1 a charge station having a plurality of AC and DC powered electrical conductors being automatically coupled with receiving type electrical conductors in a vehicle, using inductive magnetic attraction for this mechanical coupling,
thereby transferring electrical conductive power to the vehicle.

11. Inductive and conductive charge station according to claim 4 wherein high ampere spring loaded contacts are designed to rapidly disconnect,
and the charge stations is designed to be instantly lowered
below the normal charge stations height.

12. Inductive power transfer in a vehicle charge station facility according to claim 2 a vehicle charge station having a fixed primary inductor with a plurality of windings energized with AC, a movable secondary inductor in a vehicle, with the secondary inductor having a similar plurality of windings, with the secondary non-energized inductor moved by the vehicle into close proximity to the first inductor, after which the energizing magnetically attracts and locks the two inductors together, achieving energy efficient inductive power transfer from primary to secondary inductor,

13. Dual power, inductive and conductive, vehicle charge station facility according to claim 1,
a vehicle charge station having a fixed primary inductor
with a plurality of windings energized with AC,
a movable secondary inductor in a vehicle, with the inductor having a similar plurality of windings, with the secondary non-energized inductor moved by the vehicle, having a driver, moving the vehicle into close proximity to the first inductor,
after which the energizing magnetically attracts and locks the two inductors together, achieving energy efficient inductive power transfer from primary to secondary inductor, additionally, by introducing a reversing DC in primary or secondary, making two north poles or two south poles, the primary and secondary will repel and disconnect.
also, additionally, an alternate charge method using an AC powered electrical connector in the charge station, being mated with a receiving electrical connector in the vehicle, thereby transferring electric conductive power to the vehicle automatically.

14. Dual power, inductive and conductive, vehicle charge station facility according to claim 1 a vehicle charge station having a fixed primary inductor
with a plurality of windings energized with AC,
a movable secondary inductor in a vehicle, with the inductor having a similar plurality of windings, with the secondary non-energized inductor moved by the vehicle, having a driver, moving the vehicle into close proximity to the first inductor,
after which the energizing magnetically attracts and locks the two inductors together, achieving energy efficient inductive power transfer from primary to secondary inductor, also additionally, an alternate charge method using an AC powered electrical connector in the charge station, being mated with a receiving electrical connector in the vehicle, thereby transferring electric conductive power to the vehicle automatically, without the driver having to attach or manipulate anything in the charge facility.

15. Dual power, inductive and conductive, charge station according to claim 2 wherein the movement of the vehicle into close proximity
to the primary inductor is guided by a beam of a laser or LED light

16. Dual power, inductive and conductive, charge station according to claim 2 wherein the plurality of windings in either, or in both, the primary or in the secondary are connected in series or in parallel to achieve a multitude of charge voltages.

17. Dual power, inductive and conductive, charge station according to claim 2 wherein the movement of the vehicle into close proximity to the primary inductor is guided by a beam of a laser or LED light emitted by the station,
received and translated into motorized vehicle motion.

18. Dual power, inductive and conductive, charge station according to claim 6 wherein the movement of the vehicle into close proximity to the primary inductor is guided by “global positioning system” (GPS) into the location of both the primary and secondary, received and translated into motorized vehicle motion,
and the vehicle is “driver-less”.

19. Inductive power transfer in a vehicle charge station according to claim 1 wherein the charge station is having a carrying handles and is transportable.

20. Dual power, inductive and conductive, charge station according to claim 2 wherein the primary inductor or secondary inductor is fixed to a gimbal mount allowing north-south and east-west motion, and an up-down motion using
a hand-adjustable or a motor-adjustable treaded rod
allowing for pre-programmable inductor location according to vehicle dimensions.

21. Dual power, inductive and conductive, charge station according to claim 1 wherein the charger station is available in 3 version: A a simple home/garage type with no up-down adjustment, inexpensive enough, and small enough to carry in the drivers trunk, with plug-in means into a motel outlet, B same but with up-down adjustment, C a store type version with license plate reader and “customer credit card information on file”, with up-down adjustment.

22. An electric charger connectable to an electric vehicle according to claim 2
an electric charger having a plurality of electrical contacts
inside a tubular envelope formed with an angled entryway,
the charger attached to a horizontal bar, attached to a tower secured on the ground, a cylindrical charge module on a vehicle having substantially mating dimensions with the tubular envelope, and also having substantially mating electrical contacts, the module attached on the side of a vehicle, moving towards and enter the charger and thereby making electrical contact with the chargers plurality of electrical contacts.

23. An electric charger connectable to an electric vehicle according to claim 1 wherein the chargers tubular envelope is swivel-mounted in the tower to allow the envelope to move left and right, as well as up and down,

24. An electric charger connectable to an electric vehicle according to claim 1 Wherein the chargers tubular envelope is mounted on a hinge and is spring-loaded to allow for mis-alignment between the charger and the vehicle,
and the tubular dimensions and mating dimension,
allows the module to pass through the charger, and furthermore allows
the charger to pass underneath the vehicles rear view mirror.
